(19) United States
(12) Patent Application Publication
(10) Pub. No.: US 2011/0079936 A1
(43) Pub. Date: Apr. 7, 2011

(54) Methods and Apparatus for Variable Property Rapid Prototyping

(76) Inventor: Neri Oxman, Cambridge, MA (US)

(21) Appl. No.: 12/898,694

(22) Filed: Oct. 5, 2010

Related U.S. Application Data
(60) Provisional application No. 61/248,555, filed on Oct. 5, 2009.

(51) Int. Cl. B29C 47/06

(52) U.S. Cl. 264/176.1; 425/113

(57) ABSTRACT

In an exemplary implementation of this invention, a plurality of materials are heated, mixed and extruded from a nozzle. The ratio of materials in the extruded mixture may be dynamically varied in such a way that the composition of the extruded material varies in a substantially continuous gradient. The deposited material is selectively deposited layer by layer. The composition of the resulting 3D object may vary, over at least part of its volume, in a substantially continuous gradient. Furthermore, a plurality of such nozzles may be employed, at least one of which extrudes support material and at least one of which extrudes parts material, in each case in such a way that the composition of the extruded material varies in a substantially continuous gradient.

### RELATED APPLICATIONS

This application claims the benefit of United States Provisional Application Ser. No. 61/248,555, filed Oct. 5, 2009, the entire disclosure of which is herein incorporated by reference.

### FIELD OF THE TECHNOLOGY

The present invention relates generally to rapid prototyping.

### SUMMARY

In an illustrative implementation of this invention, an improved method of fused deposition is used in which a plurality of materials are heated, mixed and extruded through a nozzle. The ratio of the materials being mixed may be dynamically varied in such a manner that the composition of the extruded mixture varies in a substantially continuous gradient.

For example, thermoplastics with differing properties may be melted, mixed together and extruded through a nozzle. The ratio of the different thermoplastics being mixed may be dynamically varied, in such a way that the composition of the extruded thermoplastic mixture varies in a substantially continuous gradient.

In an illustrative implementation of this invention, the extruded mixture is selectively deposited layer by layer, building up a three-dimensional object. The nozzle is moved horizontally and vertically in this selective deposition process. The movement of the nozzle may be numerically controlled by one or more processors.

In an illustrative implementation of this invention, a thermoplastic mixture is extruded, and hardens immediately after extrusion.

The resulting 3D object may vary in structure or composition over its volume. This variation may be substantially continuous.

According to principles of this invention, an array of nozzles may be employed. At least one of the nozzles may be adapted to extrude a support material that is used to support the 3D object during deposition, and that is later removed from the 3D object. At least one other nozzle may be adapted to extrude material that remains in the 3D object after the support material is removed (“parts material”). A deposited layer may comprise a 2D pattern of parts material and support material. In each case (whether the nozzle extrudes parts material or support material), the nozzle may extrude material that varies in composition in a continual gradient.

It is helpful to briefly compare the present invention with two existing technologies.

In one existing technology, fused deposition is effected with an array of nozzles. Each nozzle in the array extrudes a single material that does not vary substantially in composition. Various nozzles are used to deposit various materials, so that the composition of the deposited layers differs discretely from layer to layer. This is quite different from the present invention, which may allow a substantially continual gradient in composition from layer to layer, or even within a particular layer.

In a second existing technology, both parts material and support material are extruded. However, each nozzle is adapted to extrude a single material that does not vary in composition. Neither the parts material nor the support material varies in composition from layer to layer, or within a single layer, in a substantially continuous manner.

The above description of the present invention is just a summary. It is intended only to give a general introduction to some illustrative implementations of this invention. It does not describe all of the details of this invention. This invention may be implemented in many other ways.

### BRIEF DESCRIPTION OF THE DRAWINGS

FIG. 1 is a block diagram of apparatus that includes an array of nozzles, in an illustrative implementation of this invention.

FIG. 2 is a block diagram of apparatus that includes only a single nozzle, in an illustrative implementation of this invention.

FIG. 3 is a block diagram of apparatus in which melting and mixing occur in separate chambers, in an illustrative implementation of this invention.

FIG. 4 is a block diagram of multiple layers deposited by a nozzle, in an illustrative implementation of this invention.

FIG. 5 shows apparatus for mixing and melting three different types of material and extruding them through a nozzle, in a prototype of this invention.

### DETAILED DESCRIPTION

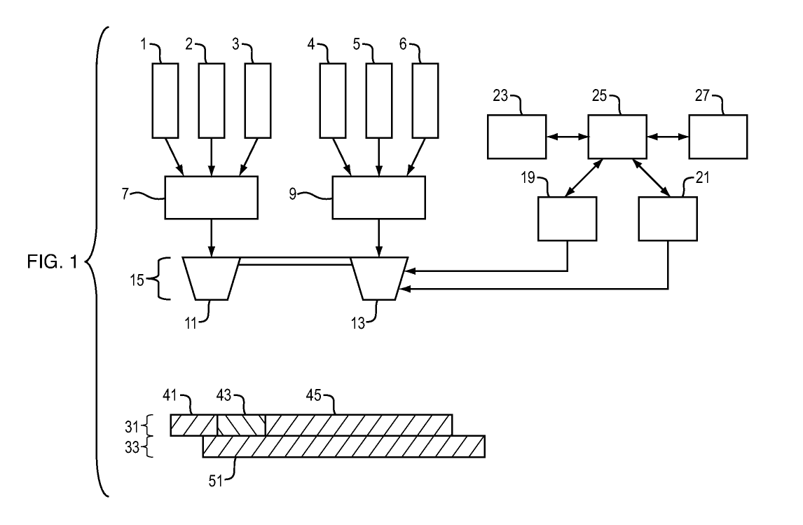

FIG. 1 is a block diagram that shows an illustrative implementation of this invention. Three different materials are inserted into chamber 7 by actuators 1, 2 and 3, respectively. In chamber 7, the three different materials are melted and mixed. The resulting mixture is then extruded through nozzle 11.

Similarly, another three different materials are inserted into chamber 9 by actuators 4, 5 and 6, respectively. In chamber 9, these three different materials are melted and mixed. The resulting mixture is then extruded through nozzle 13.

Each of the three actuators 1, 2, 3 can independently vary the rate of flow at which it inserts material into chamber 7, in such a way that the rate of flow varies substantially continuously. Thus, the three actuators 1, 2, 3 can vary the ratio of materials being inserted into chamber 7, in such a manner that the ratio of materials in the mixture exiting through nozzle 11 varies substantially continuously.

Similarly, each of the three actuators 4, 5, 6 can independently vary the rate of flow at which it inserts material into chamber 9, in such a way that the rate of flow varies substantially continuously. Thus, the three actuators 4, 5, 6 can vary the ratio of materials being inserted into chamber 9, in such a manner that the ratio of materials in the mixture exiting through nozzle 13 varies substantially continuously.

Nozzles 11 and 13 comprise an array of nozzles 15. An actuator 19 moves the nozzle array 15 horizontally. Another actuator 21 moves the nozzle array 15 vertically. For example, actuators 19 and 21 may be stepper motors.

As the nozzle moves, it selectively deposits the extruded mixture layer by layer. FIG. 1 shows a cross sectional view of two such layers 31, 33. In the example shown in FIG. 1, layer 31 comprises both parts material 41, 45 and support material 43. Layer 33 comprises only parts material 51.

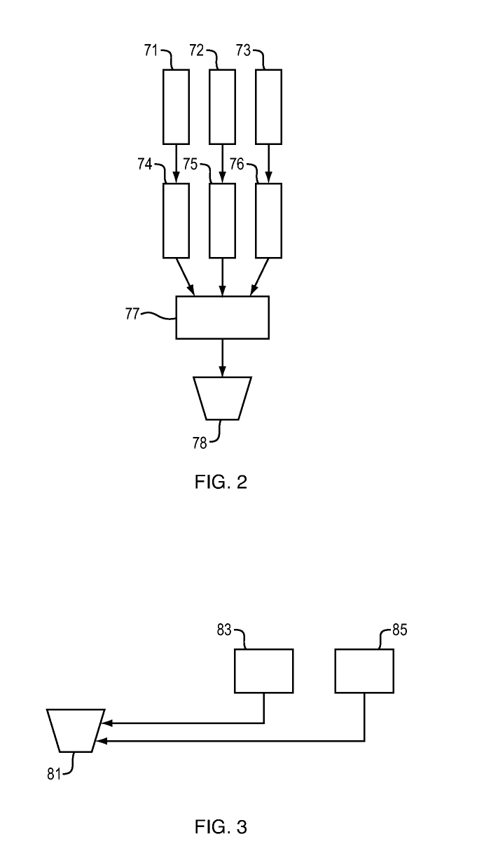

Alternately, the melting and mixing may be done in separate chambers. For example, FIG. 2 is a block diagram that shows separate melting and mixing of materials, in an exemplary implementation of this invention. Three different materials are inserted into heating chambers 74, 75 and 76 by actuators 71, 72 and 73, respectively. In chambers 74, 75 and 76, respectively, the three different materials are melted. The melted materials are then mixed in chamber 77 and the resulting mixture is extruded through nozzle 78.

Actuators 71, 72, and 73 can independently vary the rate of flow at which they insert material into chambers 74; 75 and 76, respectively, in such a way that the rate of flow varies substantially continuously. By so varying the rates of flow, the ratio of materials being inserted into chamber 77 may be varied substantially continuously, and the ratio of materials in the mixture exiting through nozzle 78 may be varied substantially continuously.

This invention may be implemented so that the rate of flow of materials (and thus ratio of materials entering a chamber or exiting through a nozzle) may be varied dynamically throughout selective deposition.

Alternately, only a single nozzle may be used, rather than an array of nozzles. For example, FIG. 3 is a block diagram that shows only a single nozzle 81. Actuators 83 and 85 move the nozzle horizontally and vertically, respectively, during selective deposition of material extruded from nozzle 81.

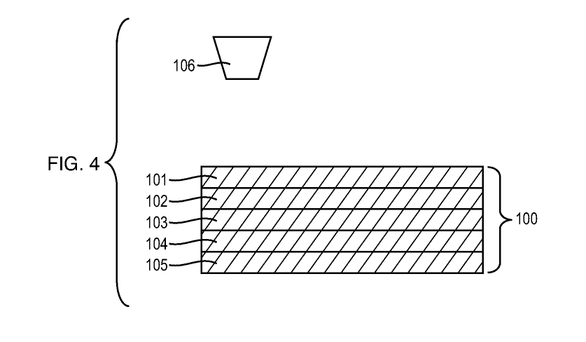

In an illustrative implementation of this invention, the ratio of materials in the extruded mixture may be varied in such a way that the composition of the 3D object being created varies substantially continuously from layer to layer, or even within a single layer. For example, FIG. 4 is a block diagram of a 3D object 100 comprising five layers 101, 102, 103, 104, 105 of material extruded by a nozzle 106. In this example, the ratio of materials extruded through nozzle 106 is varied during selective deposition in such a way that the composition of the 3D object 100 varies substantially continuously from layer to layer across layers 101, 102, 103, 104 and 105. Furthermore, in this example, the ratio of materials extruded through nozzle 106 is varied during selective deposition in such a way that the composition of the 3D object 100 varies substantially continuously within each of layers 101, 102, 103, 104 and 105. Thus, the ratio of materials being extruded through nozzle 106 may be varied during selective deposition in such a way that the composition of the 3D object 100 varies substantially continuously over at least part of the volume of such 3D object.

This invention may be implemented in such a way that at least some of the variations are not substantially continuous, but are gradual. For example, one or more of the following variations may be gradual: (a) the variation in rate of material being fed into a chamber by an actuator, (b) the variation in the ratio of the materials being mixed and extruded, (c) the variation in composition, from layer to layer, of a 3D object that is produced by selective deposition, and (d) the variation in composition, within any particular layer, of a 3D object that is produced by selective deposition

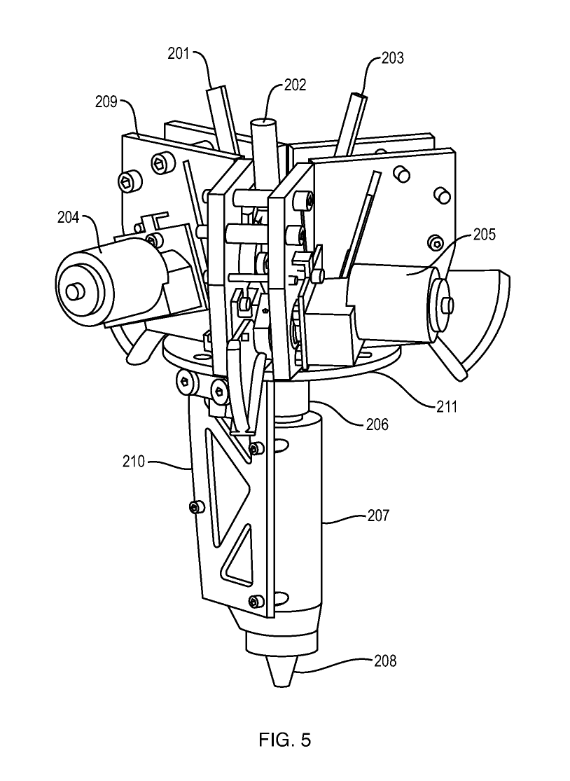

FIG. 5 shows apparatus for mixing and melting three different types of material and extruding them through a nozzle, in a prototype of this invention. Glue sticks 201, 202 and 203 comprise three different materials, in that each of them has a different color. These glue sticks are moved by three different pusher assemblies (actuators) into heating chamber 207, where they are mixed and melted. The resulting mixture is extruded through a nozzle 208. The pusher assemblies are each powered by a 9V motor. Two of these motors, 204, 205, are shown. A baseplate bushing 206 guides the glue sticks into heating chamber 207. Structural elements include a side plate 209 of one of the pusher assemblies, a baseplate 211, and a nozzle cradle 210. Each of the pusher assemblies can independently vary the rate at which its respective glue stick enters heating chamber 207, in such a manner that the variation is a continuous gradient. Thus, the pusher assemblies can vary the ratio of the different colors of glue entering heating chamber 207, in such a way that the variation is a continuous gradient.

In the example shown in FIG. 1, a processor 25 uses software 23 to output instructions that control the movement of the nozzle array 15. When doing so, the processor 25 accesses data stored in memory 27, which data comprises a digital model of the three-dimensional object being created by rapid prototyping.

This digital model may employ voxels to compute properties that vary over a gradient across one or more dimensions. Voxels are advantageous for this purpose because of their representation of discrete elements defining a continuous whole, able to carry 3D information (e.g., scalars, vectors) as well as tensors (e.g., physical information). For example, in some implementations of this invention, the software may treat voxels as tensors (geometrical entities with multiple physical parameters). In some implementations, the software may compute transitions between multiple compositional phases using extrapolation functions.

This invention may be implemented in such a way that software computations distinguish between volumetric regions in which properties do not vary, and volumetric regions in which they do. A processor may output layer-by-layer pixel sheets such that when they are stacked they are represented as voxel clouds. These pixel sheets may be used to generate instructions for selective deposition of material.

This invention may be implemented using various types of rapid prototyping techniques, including various types of layer manufacturing and fused deposition.

Different types of material may be extruded. For example, a variety of thermoplastics and elastomers may be extruded, depending on how this invention is configured or performed.

This invention has many practical applications. Among other things, it may be used to 3D print a wide variety of functionally graded materials.

This invention may be implemented in many different ways. Here are a few examples:

This invention may be implemented as apparatus for fused deposition, comprising (a) at least one nozzle for extruding material, (b) at least one actuator for moving said nozzle, and (c) at least one chamber adapted for mixing a plurality of materials for extrusion though said nozzle, in such a manner that the ratio of said materials in said extruded mixture varies in a substantially continuous gradient. Furthermore: (1) said apparatus may be adapted to produce a 3D object the composition of which varies, over at least part of its volume, in a substantially continuous gradient, (2) said at least one actuator may be adapted to move said nozzle in such a way as to selectively deposit said extruded material layer by layer, (3) said apparatus may be adapted to produce a 3D object by layered manufacturing, in such a way that the composition of materials differs from layer to layer in a substantially continuous gradient between at least some layers, (4) said apparatus is adapted to produce a 3D object by layered manufacturing, in such a way that the composition of materials differs within a layer in a substantially continuous gradient, (5) said plurality of materials may comprise a plurality of different thermoplastics, 6) said plurality of materials may comprise a plurality of different elastomers, (7) said actuator may be a stepper motor, (8) said chamber may be adapted for melting said plurality of materials, (9) said apparatus may include at least one chamber adapted for said mixing at least two of said plurality of materials and may also include at least one other chamber adapted for melting at least one of said plurality of materials, (10) said nozzle may be one of an array of nozzles, and at least one of the other nozzles in said array may be adapted for extruding a support material that is adapted to be removed after said deposition.

This invention may be implemented as a method of layer manufacturing, comprising (a) extruding material through at least one nozzle, (b) moving said nozzle in a such a manner as to selectively deposit said extruded material layer by layer, (c) mixing a plurality of materials and (d) extruding said mixture through said nozzle in such a manner that the ratio of these materials in the extruded mixture varies in a substantially continuous gradient. Furthermore: (1) said ratio may be varied in such a way that said fused deposition produces a 3D object, the composition of which varies, over at least part of its volume, in a substantially continuous gradient, (2) said layer by layer deposition may be done in such a way that the composition of deposited material differs from layer to layer in a substantially continuous gradient between at least some layers, (3) said layer by layer deposition may be done in such a way that the composition of deposited material differs within a layer in a substantially continuous gradient, (4) a stepper motor may be used to actuate the motion of said nozzle, and (5) said plurality of materials may be melted in said chamber.

This invention may be implemented as apparatus for layer manufacturing, comprising (a) at least one nozzle for extruding material, (b) at least one actuator for moving said nozzle in such a way as to selectively deposit said extruded material layer by layer, and (c) at least one chamber adapted for mixing a plurality of materials for extrusion though said nozzle, in such a manner that the ratio of said materials in said extruded mixture varies gradually. Furthermore: (1) said apparatus may be adapted to produce a 3D object the composition of which varies gradually over at least part of its volume, and (2) said nozzle may be one of an array of nozzles, and at least one of the other nozzles in said array may be adapted for extruding a support material that is adapted to be removed after said deposition.

### CONCLUSION

It is to be understood that the methods and apparatus which have been described above are merely illustrative applications of the principles of the invention. Numerous modifications may be made by those skilled in the art without departing from the scope of the invention. The scope of the invention is not to be limited except by the claims that follow.

What is claimed is:

1. Apparatus for fused deposition, comprising at least one nozzle for extruding material and at least one actuator for moving said nozzle,
The Improvement Comprising at least one chamber adapted for mixing a plurality of materials for extrusion though said nozzle, in such a manner that the ratio of said materials in said extruded mixture varies in a substantially continuous gradient.

2. The apparatus of claim 1, wherein said apparatus is adapted to produce a 3D object the composition of which varies, over at least part of its volume, in a substantially continuous gradient.

3. The apparatus of claim 1, wherein said at least one actuator is adapted to move said nozzle in such a way as to selectively deposit said extruded material layer by layer.

4. The apparatus of claim 1, wherein said apparatus is adapted to produce a 3D object by layered manufacturing, in such a way that the composition of materials differs from layer to layer in a substantially continuous gradient between at least some layers.

5. The apparatus of claim 1, wherein said apparatus is adapted to produce a 3D object by layered manufacturing, in such a way that the composition of materials differs within a layer in a substantially continuous gradient.

6. The apparatus of claim 1, wherein said plurality of materials comprises a plurality of different thermoplastics.

7. The apparatus of claim 1, wherein said plurality of materials comprises a plurality of different elastomers.

8. The apparatus of claim 1, wherein said actuator is a stepper motor.

9. The apparatus of claim 1, wherein said chamber is adapted for melting said plurality of materials.

10. The apparatus of claim 1, wherein at least one chamber is adapted for said mixing at least two of said plurality of materials and at least one other chamber is adapted for melting at least one of said plurality of materials.

11. The apparatus of claim 1, wherein said nozzle is one of an array of nozzles, and wherein at least one of the other nozzles in said array is adapted for extruding a support material that is adapted to be removed after said deposition.

12. A method of layer manufacturing, comprising extruding material through at least one nozzle, and moving said nozzle in a such a manner as to selectively deposit said extruded material layer by layer,
The Improvement Comprising mixing a plurality of materials and extruding said mixture through said nozzle in such a manner that the ratio of these materials in the extruded mixture varies in a substantially continuous gradient.

13. The method of claim 12, wherein said ratio is varied in such a way that said layer manufacturing produces a 3D object, the composition of which varies, over at least part of its volume, in a substantially continuous gradient.

14. The method of claim 12, wherein said layer by layer deposition is done in such a way that the composition of deposited material differs from layer to layer in a substantially continuous gradient between at least some layers.

15. The method of claim 12, wherein said layer by layer deposition is done in such a way that the composition of deposited material differs within a layer in a substantially continuous gradient.

16. The method of claim 12, wherein a stepper motor is used to actuate the motion of said nozzle.

17. The method of claim 12, further comprising the step of melting said plurality of materials in said chamber.

18. Apparatus for layer manufacturing, comprising at least one nozzle for extruding material and at least one actuator for moving said nozzle in such a way as to selectively deposit said extruded material layer by layer,
The Improvement Comprising at least one chamber adapted for mixing a plurality of materials for extrusion though said nozzle, in such a manner that the ratio of said materials in said extruded mixture varies gradually.

19. The apparatus of claim 18, wherein said apparatus is adapted to produce a 3D object the composition of which varies gradually over at least part of its volume.

20. The apparatus of claim 18, wherein said nozzle is one of an array of nozzles, and wherein at least one of the other nozzles in said array is adapted for extruding a support material that is adapted to be removed after said deposition.
